(19) United States
(12) Patent Application Publication
(10) Pub. No.: US 2002/0109578 A1
(43) Pub. Date: Aug. 15, 2002

(54) Integrated display and identification system and method

(76) Inventor: Glenn S. Hansen, Oviedo, FL (US)

Correspondence Address: Jacqueline E. Hartt, Ph.D., Allen, Dyer, Doppelt, Milbrath & Gilchrist, P.A., 255 South Orange Avenue, Suite 1401, P.O. Box 3791, Orlando, FL, 32802-3791, US

(21) Appl. No.: 09/780,959

(22) Filed: Feb. 9, 2001

(51) Int. Cl. G05B 23/02; H04L 9/00

(52) U.S. Cl. 340/3.1

(57) ABSTRACT

Identification of a user and authorization for the user to interact with a processor are achieved using a transponder that has an identification code programmed thereinto. A detector integrally mounted with a display screen automatically receives an electromagnetic signal from the transponder that is indicative of the identification code. The signal is transduced into an electronic signal that is transmitted signal to a processor, where it is compared with a set of approved user signals and for issuing an approval code. A receipt of the approval code permits an interaction between the user and the processor and causes a display of a communication from the processor to the user. A wireless transfer of data from the processor to a user device is also permitted upon approval.

### BACKGROUND OF THE INVENTION

1. Field of the Invention

The present invention relates to communications systems, and, more particularly, to such systems for contactless identification of a proximate user and for authorizing an interface with a processor via a display device.

2. Description of Related Art

Members of groups of people often have need to access a common processor via a display monitor, or perhaps via a plurality of display monitors. Authorization is typically required for such access, which is known in the art to be accomplished via the entry of a password or by swiping a card having an encoded magnetic strip attached thereto through a reader.

A method is described by Theimer et al. (U.S. Pat. No. 5,611,050) that includes an ability to control and register interactions of mobile users with computational resources.

It is known to use transponder devices to identify a person or an object within a defined proximity (Thomas et al., U.S. Pat. No. 5,317,318; Carroll et al., U.S. Pat. No. 5,517,188;Marsh et al., U.S. Pat. Nos. 5,537,105 and 5,557,280; Tyren et al., U.S. Pat. No. 5,557,085; Gelnovatch et al., U.S. Pat. No. H1,606; and Tokuda et al., U.S. Pat. No. 5,642,103).

### SUMMARY OF THE INVENTION

It is therefore an object of the present invention to provide a system and method for identifying a member of a group and for authorizing the member's interaction with a processor.

It is an additional object to provide such a system and method that includes a wireless identification capability.

It is a further object to provide such a system and method that includes wireless identification capability with an existing electronic device and data transfer therebetween.

It is another object to provide such a system that has means for connecting to a network.

It is yet an additional object to provide an integrated device for performing the identification and interaction.

It is yet a further object to provide such a device that improves ease of access to the processor while maintaining security.

These objects and others are attained by the present invention, a device, system, and associated methods for providing identification of a user and authorization for the user to interact with a processor. The system comprises a transponder that has an identification code programmed thereinto. The transponder in a particular embodiment comprises a standalone portable personal identification device. In an alternate embodiment the transponder comprises a component of an existing electronic device that is wearable or portable by the user.

The device comprises a detector that is adapted to receive an electromagnetic signal from the transponder that is indicative of the identification code. The electromagnetic signal is within a predetermined wavelength range, such as, for example, the radio frequency range. The detector is also adapted to transduce the electromagnetic signal into an electronic signal and to transmit the electronic signal to a processor.

The processor to which the signal is routed has software means resident therein for comparing the electronic signal with a set of approved user signals and for issuing an approval code. In an alternate embodiment the processor also has software resident therein and is in electronic communication with hardware means adapted to initiate a high-speed data exchange between the device and a unit within which the transponder is housed.

The system additionally comprises display means mounted to the housing integrally with the detector. The display means is connectable for electronic communication with the processor, and is adapted to receive the approval code therefrom. A receipt of the approval code permits an interaction between the user and the processor and causes a display of a communication from the processor to the user.

In a particular embodiment contemplated, each member of a group would have a personal identification device carried on his/her person during the performance of a particular activity. For example, the system may be used by waitpersons at a restaurant for obtaining access to an intranet-based processor for entering orders and processing checks. Alternatively, members of a group spending time within the predetermined area could be given one of these devices until leaving the area to permit access to an informational kiosk to permit intragroup communications. The particular application has been disclosed in the present inventor's copending patent application Ser. No. 09/510,758, the disclosure of which is incorporated herein by reference.

Other areas of potential application include, but are not intended to be limited to, students, faculty, and staff of a school or university; doctors, nurses, and other staff of a hospital, clinic, or doctor's or dentist's office; a laboratory conducting sensitive, classified or potentially dangerous research; and staff of a financial institution such as a bank or investment trading facility. The invention is contemplated for use in any location wherein security and personnel identification is desired.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a schematic representation of the identification and authorization system of the present invention.

FIG. 2 is a schematic of the interaction between the transponder and the reader.

FIG. 3 is a block diagram of the identification system.

FIG. 4 is a schematic representation of an alternate embodiment of the system.

### DETAILED DESCRIPTION OF THE PREFERRED EMBODIMENTS

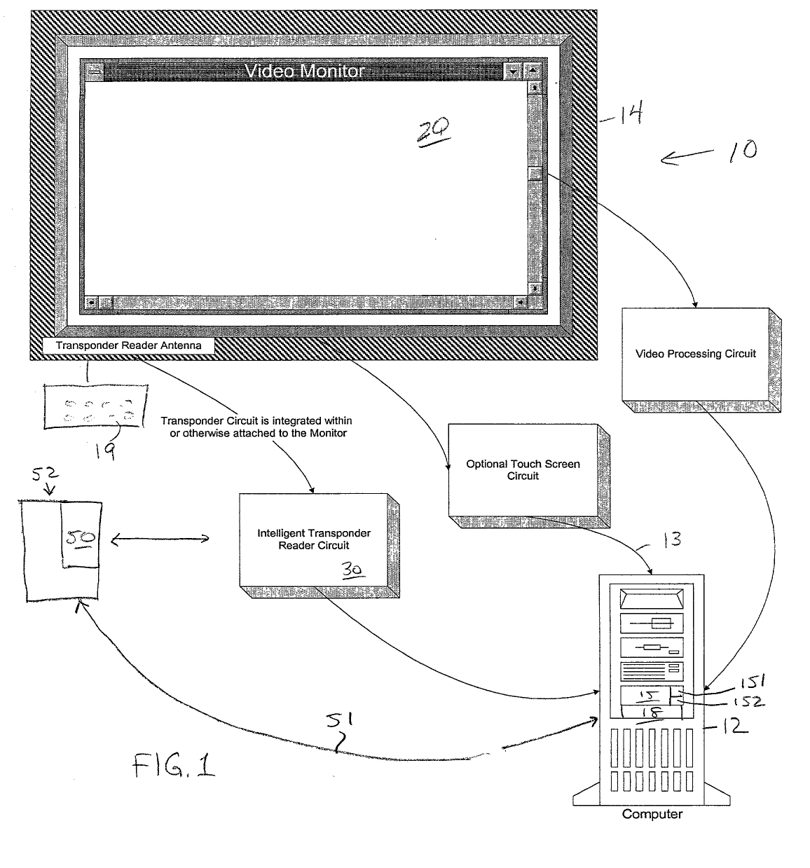

A description of the preferred embodiments of the present invention will now be presented with reference to FIGS. 1-4.

The system 10 of the present invention in a particular embodiment is intended for permitting and authorizing communication between a user carrying an identification device 50. In a particular embodiment the identification device 50 is part of, or housed within, a personal communication and/or processing device 52 such as, but not intended to be limited to, a portable computer, a personal data recording device, a cellular telephone, a watch, or a badge. The system 10 may operate over an intranet in defined area, such as a restaurant, campus, theme park, a resort, a hotel/shopping complex, or a large business. In another embodiment the system 10 operates via an internet, which does not materially change the operation of the invention. In yet another embodiment of the invention, the system 10 operates as a unitary, standalone device.

The intranet embodiment of the system 10 (FIG. 1) includes a processor, such as a central computer 12, networked, for example, via lines 13, to a plurality of interaction stations 14. Resident on the computer 12 and/or accessible thereby is a database 15 containing a list 151 of authorized user codes and, in a particular embodiment, at least one set of data 152. Preferably a plurality of data sets 152 are present, each data set 152 accessible in correlation with a particular set of user codes. As an example, a particular group of users having a set of user codes are authorized to access a particular set of data, such as contact or scheduling information for the group. The computer 12 comprises a software package 18 installed thereon, the properties of which will be discussed in the following.

Input means affixed to each interaction station 14 are connectable for electronic communication with the computer 12 for permitting an interaction between the user and the computer 12. The input means may comprise devices such as are known in the art, for example, a keyboard 19.

A display device 20 is affixed at the interaction station 14 for access by a user and is in electronic communication with the computer 12, here over the intranet lines 13. The display device 20 in a preferred embodiment may comprise a video display screen, most preferably a touch screen such as are known in the art. A touch screen is adapted to transduce a physical contact therewith into a location-dependent electronic signal that may be transmitted to the computer 12. In this embodiment, therefore, the touch screen may also act as an input device. Such screens may be selected from a group consisting of a flat panel liquid crystal display and a gas plasma display, although these are not intended as limitations.

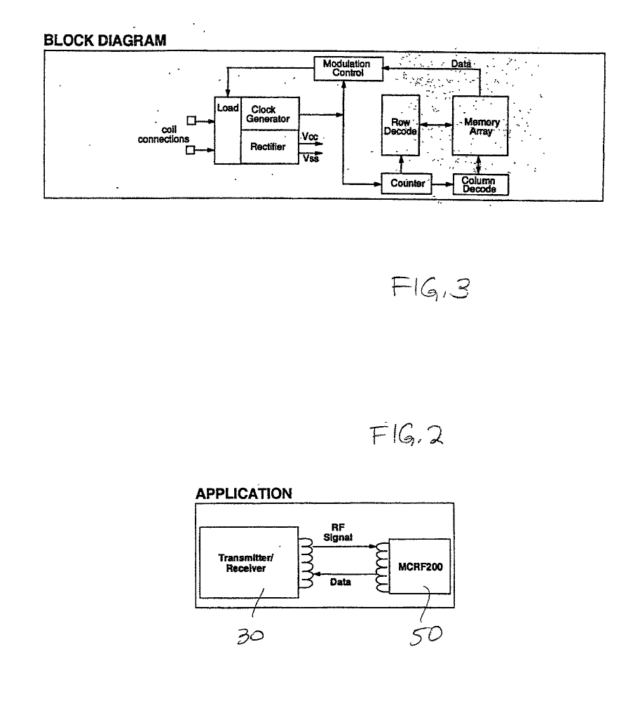

A detector adapted for communication with the identification device 50 is integrally affixed with the display device 20 at the interaction station 14. In a preferred embodiment the detector/identification device pair comprises a transponder reader 30 and transponder 50. An exemplary interaction between these devices is illustrated schematically in FIG. 2, although this is not intended as a limitation. Here the transponder 50 comprises a memory array containing an identification code representative of the identity of the user.

In one embodiment the transponder 50 may be adapted to transmit a signal, such as in the radio frequency region. In a preferred embodiment, however, the transponder reader 30 comprises a transmitter/interrogator supporting a bidirectional interface through inductive coupling. When the transponder 50 is within a predetermined range of the reader 30, and the reader is in a “read” mode, the transponder 50 automatically transmits the contents of its memory array by modulating the contents within an incoming signal from the reader 30. The reader 30 then detects the modulation and decodes the memory array data received. These data are then compared in the computer 12 with the database 15 of identification codes. If the incoming code matches a member of the database 15, communication with the computer 12 is enabled.

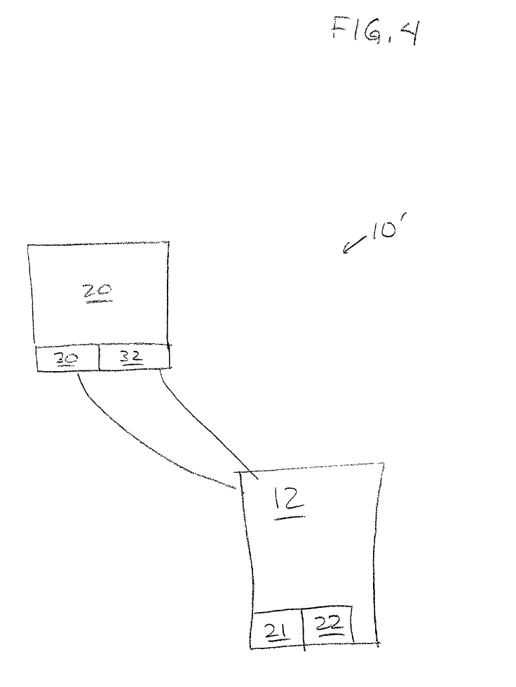

Preferably the signal emitted by the reader 30 is within the range of 125 kHz to 13.36 MHZ, in the radio frequency range. The transponder 50 may comprise a wireless or contactless, programmable or nonprogrammable, RFID transponder such as are known in the art. An exemplary schematic for the interaction between the reader 30 and the transponder 50, including the transducing and decoding of the signal, is illustrated in FIG. 3.

The system 10 thus satisfies a need for a simplified identification of users interacting with a computer 12 to retrieve desired information pertinent to the user. In the embodiment using a touch screen 20, when the user reaches out to interact with the screen 20, the reader 30 automatically interrogates a transponder 50 affixed to the user and, if a match is found in the database 15, authorizes access to the computer 12.

Another element of the system 10 comprises means for transmitting a data set 152 from the computer 12 to the user's device 52. In this aspect of the invention, the user code transmitted from the transponder 50 is correlated with a set of user codes 151, and each such set 151 is in turn correlated with a data set 152 to which access is permitted. Then the data set 152 is transmitted from the database 15 via electromagnetic energy in wireless fashion to the user's device 52, synchronizing the data between the database 15 and the user's device 52. This data transfer preferably comprises a short-term-high-speed data interchange 51 for communicating such information as, but not intended to be limited to, area maps, a meeting place, email, a message, and/or a document. This transfer is preferably performed more quickly than would be possible using traditional wireless communications methods, with speeds in the 1 Mbit/sec-1 Gbit/sec range, once a link is established between the devices 52/12. Once the synchronization is complete, the devices 52/12 exchange a signal.

In an alternate embodiment of the present invention (FIG. 4), a system 10′ also provides identification of a user and authorization for the user to interact with a processor 12. This system 10′ comprises a visual display device 20. Integrally mounted with the display 20 are a first detector 30 and a second detector 32.

The first detector 30 is, as above, adapted to receive an electromagnetic signal within a predetermined wavelength range, such as a transponder reader. The first detector 30 is further adapted to transmit the electronic signal.

The second detector 32 is adapted to receive the electronic signal from the first detector 30 and to perform thereupon a visual scan of a user. The second detector 32 is further adapted to transmit in electronic form data representative of the visual scan to the processor 12. Such a visual scan may comprise, for example, a retinal scan, a facial scan, or a fingerprint scan, although these are not intended as limitations. The processor 12 has means 21 resident therein or accessible thereby for comparing the visual scan data with a database 22 of approved user visual scan data.

Upon a match being achieved by the comparing means 21, a transmitter in electronic communication with the processor 12 transmits an approval code from the processor 12 to the visual display device 20. The approval code is for permitting interaction between the user and the processor 12 via the visual display device 20 and to display a communication from the processor 12 to the user.

Exemplary applications include access to email or other messages at intranet or internet kiosks; access to a computer system; authorization by a security system to obtain information or obtain access to an area; authorization to record and complete a sale, such as at a restaurant or retail outlet; authorization to make reservations or register for a class; and access to an information system such as by a medical professional.

It may be appreciated by one skilled in the art that additional embodiments may be contemplated, including different types of transponders, readers, and peripheral devices, and alternative identification device designs.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiment thereof, and the advantageous new and useful results obtained thereby, the new and useful constructions, and reasonable mechanical equivalents thereof obvious to those skilled in the art, are set forth in the appended claims.

What is claimed is:

1. A device for providing identification of a user and authorization for a user to interact with a processor comprising:
a detector adapted to receive an electromagnetic signal within a predetermined wavelength range, to transduce the electromagnetic signal into an electronic signal, and to transmit the electronic signal to a processor, the processor having software means resident therein for comparing the electronic signal with a set of approved user signals and for issuing an approval code; and
display means integrally mounted with the detector, connectable for electronic communication with the processor, and adapted to receive the approval code for permitting interaction between the user and the processor and to display a communication from the processor to the user.

2. The device recited in claim 1, wherein the detector comprises a transponder reader adapted to receive an electromagnetic signal from a transponder.

3. The device recited in claim 1, further comprising a transmitter adapted to transmit electronic energy within a desired frequency range to a transponder device, and wherein the detector is adapted to receive a returning electromagnetic signal from the transponder device, the returning electromagnetic signal modulated by the transponder device.

4. The device recited in claim 3, wherein the predetermined frequency range comprises at least a segment of the radio frequency region of the electromagnetic spectrum.

5. The device recited in claim 1, wherein the display means comprises a video display screen.

6. The device recited in claim 5, wherein the video display screen comprises a touch screen adapted for transducing a physical contact into a location-dependent electronic signal transmittable to the processor.

7. The device recited in claim 5, wherein the video display comprises a monitor selected from a group consisting of a flat panel liquid crystal display and a gas plasma display.

8. The device recited in claim 1, further comprising input means connectable for electronic communication with the processor and adapted to permit an interaction between a user and the processor.

9. The device recited in claim 8, wherein the input means comprises a keyboard.

10. The device recited in claim 8, wherein the input means and the display means comprise a video display touch screen adapted for transducing a physical contact into a location-dependent electronic signal transmittable to the processor.

11. The device recited in claim 1, further comprising means in electronic communication with the processor for effecting a wireless data transfer between a storage device in electronic communication with the processor and an electronic receiving unit in electronic communication with a transponder device adapted to emit the electromagnetic signal.

12. A device for providing identification of a user and authorization for the user to interact with a processor comprising:
a detector adapted to sense a presence of an identification element within a predetermined distance, to sense a code from the identification element indicative of an identity of a user, and to transmit the sensed code to a processor, the processor having software means resident therein for comparing the sensed code with a set of approved user signals and for issuing an approval code; and
display means integrally mounted with the detector, connectable for electronic communication with the processor, and adapted to receive the approval code for permitting interaction between the user and the processor and to display a communication from the processor to the user.

13. A system for providing identification of a user and authorization for the user to interact with a processor comprising:
a transponder having an identification code programmed thereinto;
a detector adapted to receive an electromagnetic signal indicative of the identification code within a predetermined wavelength range from the transponder, to transduce the electromagnetic signal into an electronic signal, and to transmit the electronic signal to a processor, the processor having software means resident therein for comparing the electronic signal with a set of approved user signals and for issuing an approval code; and
display means integrally mounted with the detector, connectable for electronic communication with the processor, and adapted to receive the approval code for permitting interaction between the user and the processor and to display a communication from the processor to the user.

14. The system recited in claim 13, further comprising input means connectable in electronic communication with the processor for permitting user interaction with the processor.

15. The system recited in claim 14, wherein the input means comprises a keyboard.

16. The system recited in claim 14, wherein the input means and the display means comprises a touch video screen.

17. The system recited in claim 13, further comprising a personal communication unit comprising the transponder and data receiving means, and wherein the software means further has means for performing communication with and retrieving data from a database in electronic communication with the processor, and further comprising a transmitter for transferring retrieved data from the communication performing and data retrieving means to the data receiving means.

18. A method for providing identification of a user and authorization for the user to interact with a processor comprising the steps of:
automatically detecting an identification code from a transponder within a predetermined energy range;
transmitting the identification code to a processor;
using software means resident in the processor to compare the identification code with a list of approved identification codes, each identification code indicative of a particular user; and
displaying an indication of approval to the user on a display device and permitting interaction with the processor by the user if the identification code matches a code on the approved code list.

19. The method recited in claim 18, wherein the detecting step comprises interrogating the transponder with an emitted electromagnetic signal.

20. The method recited in claim 19, wherein the interrogating step comprises emitting a signal in the radio frequency range, the signal modulatable by the transponder, and decoding the modulated signal to determine the identification code.

21. A system for providing identification of a user and authorization for a user to interact with a processor comprising:
a visual display device;
a first detector integrally mounted with the visual display device, the first detector adapted to receive an electromagnetic signal within a predetermined wavelength range, to transduce the electromagnetic signal into an electronic signal, and to transmit the electronic signal;
a second detector integrally mounted with the visual display device, the second detector adapted to receive the electronic signal from the first detector, to perform thereupon a visual scan of a user, and to transmit in electronic form data representative of the visual scan to a processor, the processor having means for comparing the visual scan data with a database of approved user visual scan data; and
upon a match being achieved by the comparing means, means for transmitting an approval code from the processor to the visual display device for permitting interaction between the user and the processor via the visual display device and to display a communication from the processor to the user.

22. The system recited in claim 21, wherein the visual display device comprises a touch screen adapted for transducing a physical contact into a location-dependent electronic signal transmittable to the processor.

23. The system recited in claim 21, wherein the first detector comprises a transponder reader adapted to receive a signal from a transponder.

24. A method for providing information to a user comprising the steps of:
automatically detecting an identification code transmitted from a transponder housed in a personal information device;
transmitting the identification code to a processor;
using software means resident in the processor to compare the identification code with a list of approved identification codes, each identification code indicative of a particular user;
displaying an indication of approval to the user on a display device and permitting interaction with the processor by the user if the identification code matches a code on the approved code list;
if approval is indicated, correlating the identification code with a set of data to be transmitted;
retrieving the data set from a storage device; and
transmitting the data set to the personal information device.

25. The method recited in claim 24, wherein the identification code detecting step and the data set transmitting step comprise wireless communications.
